(19) United States
(12) Patent Application Publication
(10) Pub. No.: US 2026/0276992 A1
(43) Pub. Date: Sep. 17, 2026

(54) VARIABLE DEPTH BLAZED WAVEGUIDE

(71) Applicant: GOOGLE LLC, Mountain View, CA (US)

(72) Inventors: Eliezer Glik, San Diego, CA (US); Ozan Cakmakci, San Bruno, CA (US); Matias Dieter Heinrich, Mountain View, CA (US)

(21) Appl. No.: 19/156,970

(22) PCT Filed: Feb. 15, 2023
(86) PCT No.: PCT/US2023/013114

§ 371 Date: Aug. 15, 2025

(51) Int. Cl. G02B 27/01; G02B 5/18

(52) U.S. Cl. CPC G02B 27/0172; G02B 5/1828; G02B 2027/0125; G02B 2027/0178

(57) ABSTRACT

Described techniques provide increased output uniformity in an eyebox of a reflective light guide using a reflective structure, such as a periodic reflective structure formed in one or more optical substrates of an optical combiner. The reflective structure includes a series of reflective facets having a respective reflective intensity that varies in accordance with a position of the respective facet along a path of propagation for the light guide, such as to increased reflective intensity for reflective facets positioned further from an incoupling structure of the light guide.

### BACKGROUND

The present disclosure relates generally to augmented reality (AR) eyewear, which fuses a view of the real world with a heads-up display overlay. Wearable display devices, which include wearable heads-up displays (WHUDs), eyewear display (EWD) devices, and head-mounted display (HMD) devices (all of which may be used interchangeably herein), are wearable electronic devices that combine real world and virtual images via one or more optical combiners, such as one or more integrated combiner lenses, to provide a virtual display that is viewable by a user when the wearable display device is worn on the head of the user. One class of optical combiner uses a light guide (also termed a waveguide) to transfer light. In general, display light from a projector of the wearable display device enters the light guide of the optical combiner through an incoupler, propagates along the light guide via total internal reflection (TIR), and exits the light guide through an outcoupler. If the pupil of the eye is aligned with one or more exit pupils provided by the outcoupler, at least a portion of the light exiting through the outcoupler will enter the pupil of the eye, thereby enabling the user to see a virtual image. Since the combiner lens is transparent, the user will also be able to see the real world.

### BRIEF SUMMARY OF EMBODIMENTS

In an embodiment, a light guide comprises an incoupling structure to receive display light and to direct the display light into the light guide along a propagation path; and a reflective structure to outcouple at least a portion of the display light toward an eyebox of the light guide, the reflective structure comprising a series of reflective facets having a respective reflective intensity that varies in accordance with a position of the respective facet along the propagation path.

The respective reflective intensity for each reflective facet of the series of reflective facets may increase with a distance from the incoupling structure.

The respective reflective intensity of the series of reflective facets may be modulated via a respective surface area of the reflective facets. A first reflective facet of the series of reflective facets may be further along the path of propagation than a second reflective facet of the series of reflective facets, such that a surface area of the first reflective facet is greater than a surface area of the second reflective facet.

The respective reflective intensity of the series of reflective facets may be modulated via one or more optical coatings applied to the reflective facets, such that a first set of one or more optical coatings is applied to a first reflective facet of the series of reflective facets, and such that a second set of one or more optical coatings is applied to a second reflective facet of the series of reflective facets, the first set different than the second set.

A first reflective facet of the series of reflective facets may be further along the path of propagation than a second reflective facet of the series of reflective facets, such that the reflective intensity of the first reflective facet is greater than the reflective intensity of the second reflective facet.

Each reflective facet of the series of reflective facets may be substantially parallel with respect to other reflective facets of the series of reflective facets.

A respective distance between the eyebox and each reflective facet of the series of reflective facets may be substantially identical.

A respective distance between the eyebox and each reflective facet of the series of reflective facets may vary in accordance with the position of the respective facet along the propagation path.

In an embodiment, a wearable display device may comprise the light guide described above.

In an embodiment, a method comprises receiving display light into a light guide via an incoupling structure; directing the display light through the light guide along a propagation path; and outcoupling at least a portion of the display light toward an eyebox of the light guide via a reflective structure comprising a series of reflective facets. The reflective facets have a respective reflective intensity that varies in accordance with a distance between the incoupling structure and the respective facet.

The respective reflective intensity for each reflective facet of the series of reflective facets may increase with the distance between the incoupling structure and the respective facet.

The method may further comprise modulating the respective reflective intensity of the series of reflective facets by configuring a respective surface area of the reflective facets.

A first reflective facet of the series of reflective facets may be further from the incoupling structure than a second reflective facet of the series of reflective facets, such that configuring the respective surface area of the reflective facets includes configuring the first reflective facet to have a greater surface area than a surface area of the second reflective facet.

The method may further comprise applying a first set of one or more optical coatings to a first reflective facet of the series of reflective facets, and applying a second set of one or more optical coatings to a second reflective facet of the series of reflective facets, such that the first set is different than the second set.

A first reflective facet of the series of reflective facets may be further along the path of propagation than a second reflective facet of the series of reflective facets, such that the reflective intensity of the first reflective facet is greater than the reflective intensity of the second reflective facet.

Each reflective facet of the series of reflective facets may be substantially parallel with respect to other reflective facets of the series of reflective facets.

A respective distance between the eyebox and each reflective facet of the series of reflective facets may be substantially identical.

A respective distance between the eyebox and each reflective facet of the series of reflective facets may vary in accordance with the distance between the incoupling structure and the reflective facet.

In various embodiments, a wearable display device may perform the method of any of claims 11 to 19 when in operation.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a diagram of a wearable display device in accordance with some embodiments.

FIG. 2 illustrates an example cross-sectional view of a light guide used for eyebox expansion in an EWD device.

FIG. 3 illustrates another example cross-sectional view of a light guide used for eyebox expansion in an EWD device.

FIG. 4 illustrates an example cross-sectional view of a light guide used for eyebox expansion in an EWD device in accordance with some embodiments.

FIG. 5 illustrates an example cross-sectional view of a first reflective light guide structure with substantially equisized reflective facets, in contrast with that of a second reflective light guide structure with reflective facets having a respective surface area that varies in accordance with a distance from an incoupling structure, in accordance with some embodiments.

FIG. 6 is an operational flow diagram illustrating operations for increasing output uniformity provided to an eyebox of a reflective light guide, using a reflective structure with a series of reflective facets having position-dependent reflective intensity in accordance with some embodiments.

### DETAILED DESCRIPTION

Eyewear display optics intended for all-day eyewear requires efficiency, image quality, thickness, manufacturability, resolution, artifacts, full color, reliability, and a curved look that is standard in the eyewear industry today. Current light guide architecture is associated with various limitations with respect to optics, aesthetics, manufacturing, thickness, and ophthalmic correction (prescription).

Wearable display devices for presenting AR content typically employ an optical combiner light guide (also referred to herein as a “light guide”) to convey and/or magnify display light emitted by a display to a user's eye while also permitting light from the real-world scene to pass through the light guide to the user's eye, resulting in the imagery represented by the display light overlaying the real-world scene from the perspective of the user. Typically, the light guide relies on total internal reflection (TIR) to convey light received from the display via incoupling features at one end of the light guide to outcoupling features facing the user's eye on the other end of the light guide; in certain embodiments, the light guide also includes one or more redirecting facets or other redirecting features along a path of propagation between the incoupling features and outcoupling features. The outcoupling features are configured to direct light beams from within the light guide out of the light guide such that the user perceives the projected light beams as images displayed in a field of view (FOV) area of a display component located in front of a user's eye, such as a lens of an EWD device having the general shape and size of eyeglasses. The light beams exiting from the light guide then overlap at an eye relief distance from the light guide, forming a “pupil” within which a virtual image generated by the image source can be viewed.

A relatively large FOV area and pupil are desirable in an EWD device to provide an in-focus, immersive experience to the user. It is also desirable that an EWD device be able to fit a variety of users despite differences in a relative size and position of those users' respective facial features in relation to components of the EWD. For example, one design consideration for an EWD device that can be worn by a wide range of users is the “eyebox”, or a 3D volume in space within which the pupil of an eye must be positioned in order to satisfy a series of viewing experience criteria (such as the user being able to see all four edges of a virtual image). The larger the eyebox, the larger the range of users the EWD device can accommodate.

In addition to the size of the eyebox provided by an EWD device, uniformity of output throughout that eyebox (e.g., with respect to color and intensity) is also desirable for providing a quality immersive experience to the user. Current approaches to increasing such uniformity have issues with providing a uniform output eyebox, and have typically relied on partially reflective coatings that are increasingly susceptible to non-uniformity as a remainder of the display light in the light guide outcouples, leaving less light to interface with subsequent facets along the path of propagation.

Embodiments described herein provide increased output uniformity in an eyebox of a planar (flat) or non-planar (curved) reflective light guide using a reflective structure, such as a periodic reflective structure formed in one or more optical substrates of an optical combiner. Such a periodic reflective structure typically has a period on the order of 1 mm; for visible light wavelengths (e.g., wavelengths of approximately 350 to 700 nm), diffraction from such reflective structures will be minimal (e.g., on the order of 2 arcminutes), which are reasonably close to the Nyquist resolution of cones in the human retina.

In certain embodiments, various reflective structures described herein are configured to comprise a series of parallel facets having a respective reflective intensity that is modulated based at least in part on a position of the respective facet along a path of propagation for the light guide, such as to increase that respective reflective intensity for reflective facets positioned further from an incoupling structure of the light guide. In this manner, reflective facets positioned relatively distant from the incoupling structure substantially compensate for a decreased amount of display light reaching those relatively distant facets with respect to the corresponding amount of display light reaching facets positioned closer to the incoupling structure. As used herein, reflective intensity refers to an amount of light reflected from a surface as a result of interaction with a reflective interface of that surface, such as may be affected by (as non-limiting examples) a reflectivity, a reflectance, and/or a surface area of the reflective interface.

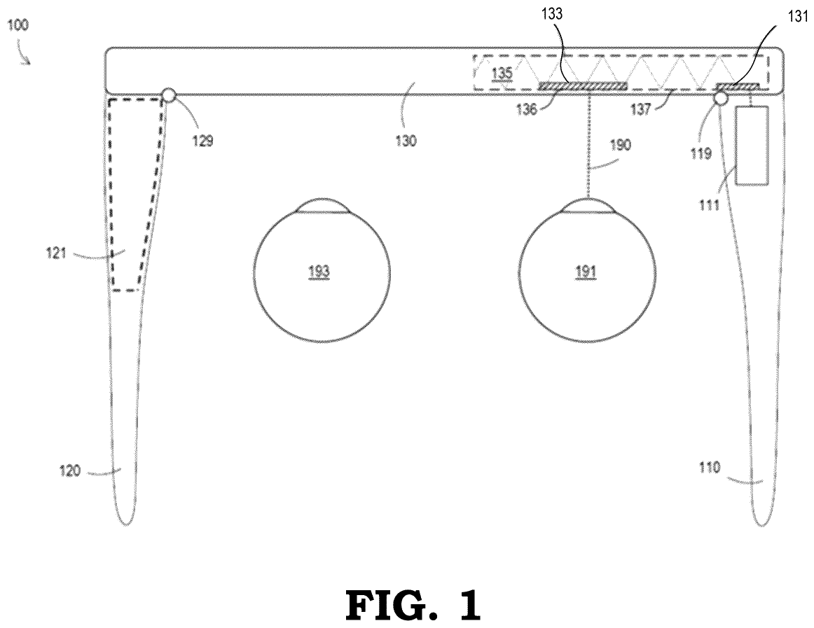

FIG. 1 illustrates a diagram of a wearable display device 100 in accordance with some embodiments. In some embodiments, the wearable display device 100 may implement or be implemented by aspects of the wearable display device 100. For example, the wearable display device 100 may include a first arm 110, a second arm 120, and a front frame 130. The first arm 110 may be coupled to the front frame 130 by a hinge 119, which allows the first arm 110 to rotate relative to the front frame 130. The second arm 120 may be coupled to the front frame 130 by the hinge 129, which allows the second arm 120 to rotate relative to the front frame 130.

In the example of FIG. 1, the wearable display device 100 may be in an unfolded configuration, in which the first arm 110 and the second arm 120 are rotated such that the wearable display device 100 can be worn on a head of a user, with the first arm 110 positioned on a first side of the head of the user, the second arm 120 positioned on a second side of the head of the user opposite the first side, and the front frame 130 positioned on a front of the head of the user. The first arm 110 and the second arm 120 can be rotated towards the front frame 130, until both the first arm 110 and the second arm 120 are approximately parallel to the front frame 130, such that the wearable display device 100 may be in a compact shape that fits conveniently in a rectangular, cylindrical, or oblong case. Alternatively, the first arm 110 and the second arm 120 may be fixedly mounted to the front frame 130, such that the wearable display device 100 cannot be folded. In the depicted embodiment, the first arm 110 carries a light engine 111; the second arm 120 carries a power source 121.

Generally, an incoupling structure (incoupler) is used to couple the light from the projector into the light guide system and an outcoupling structure (outcoupler) is used to couple propagating light out of the light guide and send the images to the human eyes. In FIG. 1, the front frame 130 carries a light guide 135 that includes an incoupling structure (incoupler) 131, an outcoupling structure (outcoupler) 133, and at least one set of electrically conductive current paths, which provide electrical coupling between the power source 121 and electrical components (such as the light engine 111) carried by the first arm 110. In other embodiments, such electrical coupling is provided indirectly, such as through a power supply circuit, or provided directly from the power source 121 to each electrical component in the first arm 110.

The light engine 111 can output a display light 190 (simplified for this example) representative of AR content or other display content to be viewed by a user. The display light 190 can be redirected by light guide 135 towards an eye 191 of the user, such that the user can see the AR content. The display light 190 from the light engine 111 impinges on the incoupler 131 and is redirected to travel in a volume of the light guide 135, where the display light 190 is guided through the light guide, such as by total internal reflection (TIR) and/or surface treatments such as holograms or reflective coatings. Subsequently, the display light 190 traveling in the volume of the light guide 135 impinges on the outcoupler 133, which redirects the display light 190 out of the light guide 135 and towards the eye 191 of a user. In the wearable display device 100, the depicted outcoupler 133 has an eye-facing surface 136 that is parallel to (and possibly coplanar with) an eye-facing surface 137 of the light guide 135. It will be appreciated that unless clearly indicated otherwise, discussions herein apply to embodiments in which the light guide 135 may be either planar (flat) or non-planar (curved).

As used herein, the terms carry, carries or similar do not necessarily dictate that one component physically supports another component. For example, it is stated above that the first arm 110 carries the light engine 111. This could mean that the light engine 111 is mounted to or within the first arm 110, such that the first arm 110 physically supports the light engine 111. However, it could also describe a direct or indirect coupling relationship, even when the first arm 110 is not necessarily physically supporting the light engine 111.

The wearable display device 100 may include a processor (not shown) that is communicatively coupled to each of the electrical components in the wearable display device 100, including but not limited to the light engine 111. The processor can be any suitable component which can execute instructions or logic, including but not limited to a micro-controller, microprocessor, multi-core processor, integrated-circuit, ASIC, FPGA, programmable logic device, or any appropriate combination of these components. The wearable display device 100 can include a non-transitory processor-readable storage medium, which may store processor readable instructions thereon, which when executed by the processor can cause the processor to execute any number of functions, including causing the light engine 111 to output the light 190 representative of display content to be viewed by a user, receiving user input, managing user interfaces, generating display content to be presented to a user, receiving and managing data from any sensors carried by the wearable display device 100, receiving and processing external data and messages, and any other functions as appropriate for a given application. The non-transitory processor-readable storage medium can be any suitable component, which can store instructions, logic, or programs, including but not limited to non-volatile or volatile memory, read only memory (ROM), random access memory (RAM), FLASH memory, registers, magnetic hard disk, optical disk, or any combination of these components.

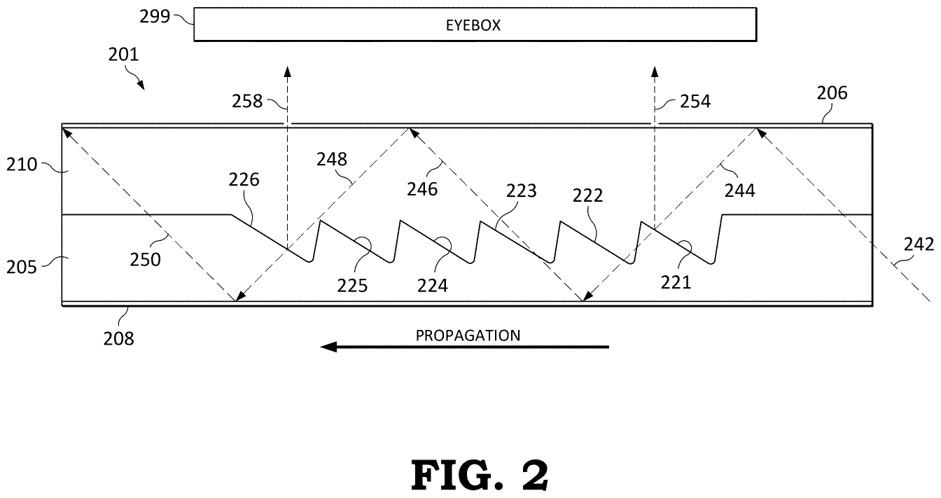

FIG. 2 illustrates an example cross-sectional view of a light guide 201 used for eyebox expansion in an EWD device (such as the wearable display device 100 of FIG. 1). The light guide 201 comprises a quantity of substantially equisized and parallel reflective facets 221, 222, 223, 224, 225, 226 (facets 221-226) formed in an optical substrate 205. In the depicted embodiment, facets 221-226 are formed as a reflective interface between the optical substrate 205 and a complementary optical substrate 210. In certain embodiments, the optical substrates 205, 210 have a substantially identical refractive index, and are coupled via one or more substantially index-matched adhesives. In various embodiments, one or more reflective coatings are applied to the interface between the complementary optical substrates 205, 210 to form reflective facets 221-226 as an internal reflective interface of a light guide 201. The light guide is externally bounded at ambient interfaces 206, 208.

In the depicted example, a display light ray 242 propagates along the light guide 201 and between ambient interfaces 206, 208 via TIR. In particular, the display light ray 242 reflects upon interacting with ambient interface 206, forming display light ray 244; the display light ray 244 reflects upon interacting with ambient interface 208, forming display light ray 246; the display light ray 246 reflects upon interacting with ambient interface 206, forming display light ray 248; and the display light ray 248 reflects upon interacting with ambient interface 208, forming display light ray 250. Notably, during such propagation, display light ray 254 is outcoupled towards an eyebox 299 via partial reflection with reflective facet 221; similarly, display light ray 258 is outcoupled towards the eyebox 299 via partial reflection with reflective facet 226. However, as light is outcoupled via display light ray 254, less light remains in the primary path represented by the display light rays 244, 246, 248, 250. Moreover, less light is reflected at facet 226 to form the outcoupled display light ray 258 relative to the outcoupled display light ray 254, leading to non-uniformity of the outcoupler display light provided at eyebox 299. As one example, using an optical coating with 50% reflectivity on the facets 221-226 and a normalized input power for display light ray 242, the relative intensity of display light ray 254 would be 50%—but the relative intensity of display light ray 258 is 50%*50%=25%. As one moves away from the incoming light direction along the general path of propagation, the light intensity—and consequently, the outcoupled light intensity—significantly drops. This change in relative power results in non-uniformity at the eyebox.

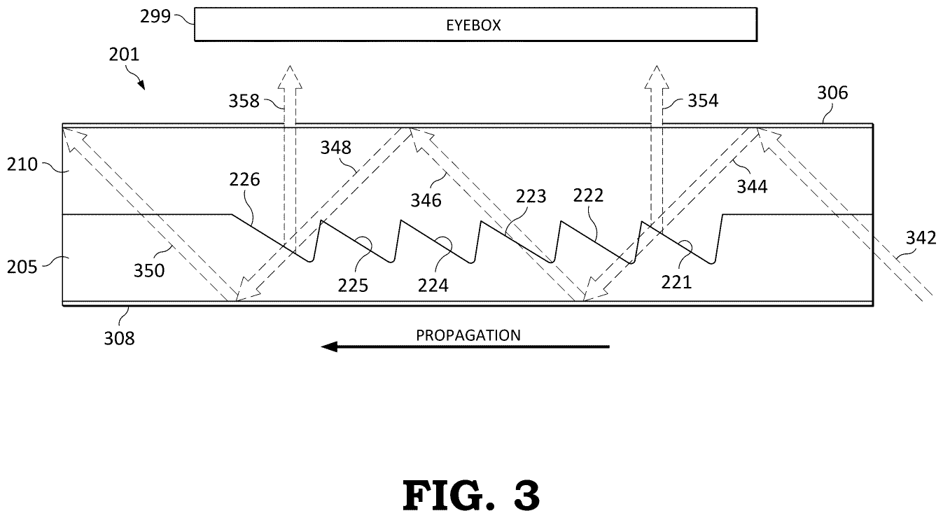

FIG. 3 illustrates another example cross-sectional view of the light guide 201. In the example of FIG. 3, the single display light rays 242, 244, 246, 248, 250 are represented instead by corresponding bundles of similarly directed rays. In particular, display light bundle 342 reflects upon interacting with ambient interface 306, forming display light bundle 344; display light bundle 344 reflects upon interacting with ambient interface 308, forming display light bundle 346; display light bundle 346 reflects upon interacting with ambient interface 306, forming display light bundle 348; and display light bundle 348 reflects upon interacting with ambient interface 308, forming display light bundle 350. Again, during such propagation, display light bundles 354, 358 are outcoupled towards the eyebox 299 via partial reflection with reflective facets 221, 226. However, the relative size of each reflective facet 221, 226 impacts the amount of total light (the sum of all rays in the respective display light bundle) that is reflected by the facet.

In certain embodiments and scenarios, if the display light bundle is sufficiently large with respect to a surface area of a reflective facet (e.g., if a width of display light bundle 348 approaches or exceeds that of reflective facet 226) then clipping will occur, in which at least a portion of the display light bundle is partially or fully occluded by the edges of one or more neighboring reflective facets (e.g., reflective facet 225). Clipping can occur when the angle of incidence of the display light on the facet exceeds a critical angle, causing the light to be reflected back into the light guide rather than being transmitted through the facet. Clipping can lead to a reduction in the overall brightness and efficiency of the light guide, and may potentially cause additional non-uniformity in the outcoupled display light reaching the provided eyebox 299.

In certain embodiments, a uniformity of outcoupler display light provided to the eyebox 299 may be increased by modulating a set of one or more reflective coatings applied to each facet 221-226, such that a respective reflective intensity of the facets 221-226 is modulated via one or more optical coatings applied to the parallel facets. For example, in an embodiment, a first set of optical coatings is applied to facet 221, and a distinct second set of optical coatings is applied to facet 226, with additional sets of optical coatings applied to the intermediate facets 222, 223, 224, 225. The overall result is that a respective reflective intensity of each facet 221-226 varies in accordance with a distance along the direction of propagation (and therefore in accordance with a distance from an incoupling structure of the light guide 201). However, applying such disparate sets of optical coatings on each reflective facet 221-226 may be process-intensive and expensive, and may hinder the effectiveness of the substantially transparent display by causing undesirable artifacts.

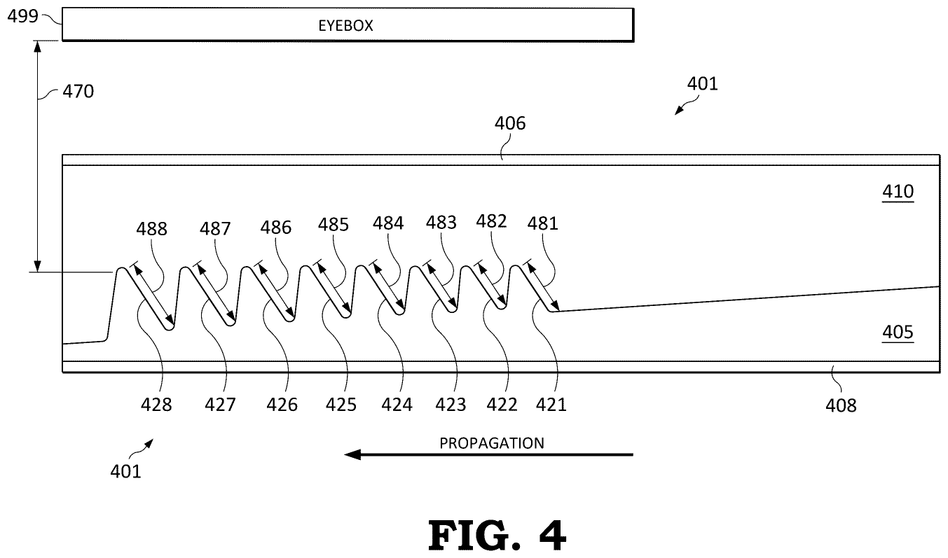

FIG. 4 illustrates an example cross-sectional view of a light guide 401 used for eyebox expansion in an EWD device (such as the wearable display device 100 of FIG. 1) in accordance with some embodiments. The light guide 401 comprises a quantity of parallel reflective facets 421, 422, 423, 424, 425, 426, 427, 428 (facets 421-428) formed as a partially reflective interface between an optical substrate 405 and a complementary optical substrate 410. In various embodiments, the optical substrates 405, 410 have a substantially identical refractive index, and are coupled via one or more substantially index-matched adhesives. Also in various embodiments, one or more reflective coatings are applied to the interface between the complementary optical substrates 405, 410 to form reflective facets 421-428 as an internal reflective interface of the light guide 401. The light guide is externally bounded at ambient interfaces 406, 408.

In the embodiment of FIG. 4, the facets 421-428 are not equisized, but instead have a respective surface area (and a corresponding respective reflective intensity) that varies in accordance with a position of the respective facet along the path of propagation. For example, in the depicted embodiment, the respective surface area of each reflective facet 421-428 corresponds to varying facet widths 481, 482, 483, 484, 485, 486, 487, 488, which increase in accordance with a distance from an incoupling structure (not shown) by which display light (not shown here) is directed into the light guide 401, and thereafter directed along the propagation path via TIR between the ambient interfaces 406, 408. That is, reflective facet 422 has a width 482 that is larger than the corresponding width 481 of reflective facet 421; reflective facet 423 has a width 483 that is larger than width 482; and so on, with the largest surface area (and correspondingly largest reflective intensity) being associated with the facet width 488 of reflective facet 428, which is positioned furthest from an incoupling structure of the light guide 401. By modulating the respective reflective intensity of the reflective facets 421-428 in this manner, the light guide 401 at least partially compensates for the disparate amount of light reaching those individual reflective facets (as discussed above with respect to FIGS. 2 and 3), increasing the uniformity of outcoupled display light presented at the eyebox 499.

In various embodiments, variations on the arrangement of optical substrates 405, 410 may be implemented without substantially altering the efficacy of the reflective facets 421-428. For example, in the depicted embodiment, the cross-sectional interface 412 between optical substrates 405, 410 appears substantially linear prior to facet 421 along the path of propagation, and formed at an acutely convergent angle with ambient interface 408. In other embodiments, the cross-sectional interface 412 may be non-linear. In still other embodiments, the cross-sectional interface 412 may be substantially parallel to, or otherwise angularly disposed with respect to, ambient interfaces 406, 408 and/or reflective facets 421-428.

In various embodiments, the relative positions of reflective facets 421-428 may be different than those depicted without substantially altering the efficacy of the reflective facets 421-428. In the depicted embodiment of FIG. 4, the topmost points of facets 421-428 are substantially equidistant from the ambient interface 408 and from the eyebox 499; however, in other embodiments such facets may be placed at varying distances from the eyebox and/or the ambient interface of the light guide. For example, in an embodiment, facet 428 may be positioned such that a distance 470 between a near edge of facet 428 and the eyebox 499 is less than a corresponding distance between a near edge of facet 421 and the eyebox 499, so as to further compensate for the lessened relative amount of display light that reaches the facet 428.

In various embodiments, the reflective structure 401 may be included as part of an optical stack with one or more additional optical components (e.g., one or more lenses, filters, polarizers, half-wave plates, and/or other optical stack components). In certain embodiments, one or more components of such an optical stack include one or more optical structures, such as additional reflective and/or diffractive structures (e.g., one or more incoupling structures, outcoupling structures, intermediate diffractive structures, intermediate reflective structures, etc.).

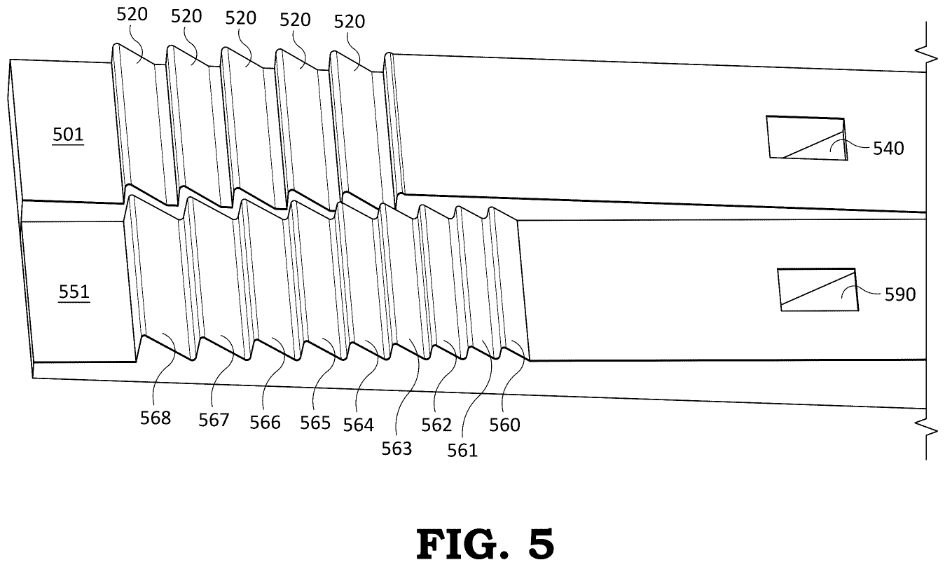

FIG. 5 illustrates an example cross-sectional view of a first reflective light guide structure 501 with substantially equisized reflective facets 520 and incoupling structure 540, and further illustrates a cross-sectional view of a second reflective light guide structure 551, which comprises reflective facets 560, 561, 562, 563, 564, 565, 566, 567, 568 (facets 560-568) that have (in a manner similar to that described above with respect to light guide 401 of FIG. 4) a respective surface area that varies in accordance with a distance from an incoupling structure 590. For ease of illustration, only a first portion of an optical substrate is included in each of reflective light guide structures 501, 551, although it will be appreciated that in various embodiments, the reflective facets 520 and 560-568 are formed as a reflective interface between complementary portions of index-matched optical substrates, as analogously described in greater detail with respect to FIGS. 2-4. It will be appreciated that although the embodiment of the reflective light guide structure 551 illustrates one-dimensional modulation of the surface area (and therefore reflective intensity) of facets 560-568, in certain embodiments a two-dimensional modulation of that surface area may be achieved as well, such as by modulating the surface area along two substantially orthogonal dimensions.

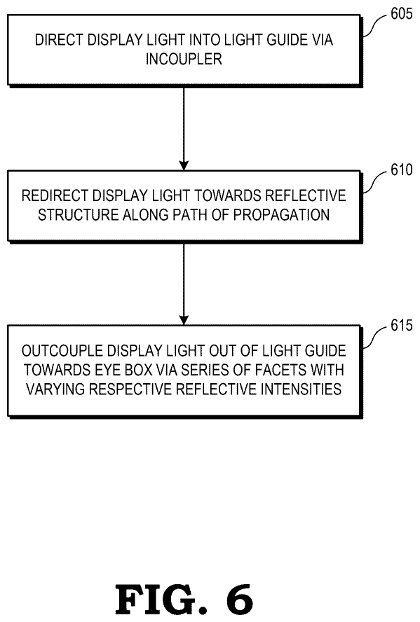

FIG. 6 is an operational flow diagram illustrating operations for increasing output uniformity provided to an eyebox of a reflective light guide using a reflective structure with a series of reflective facets having position-dependent reflective intensity in accordance with some embodiments. The illustrated operations begin at block 605.

At block 605, a display light (e.g., display light 190 of FIG. 1) is directed into the reflective light guide via an incoupler (e.g., incoupler 131 of FIG. 1, or incoupling structures 540, 590 of FIG. 5). The illustrated operations proceed to block 610.

At block 610, the display light is redirected towards a reflective structure (e.g., one of reflective structure 201 of FIGS. 2-3, reflective facets 421-428 of FIG. 4, or reflective light guide structure 551 of FIG. 5) along a path of propagation for the reflective light guide, such as via TIR. The illustrated operations proceed to block 615.

At block 615, at least a portion of the display light is outcoupled toward an eyebox of the light guide via a series of facets with respective reflective intensities that vary in accordance with a position of the facet along the path of propagation, and/or in accordance with a distance to the facet from the incoupler along that path.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A light guide, comprising:
an incoupling structure to receive display light and to direct the display light into the light guide along a propagation path; and
a reflective structure to outcouple at least a portion of the display light toward an eyebox of the light guide, the reflective structure comprising a series of reflective facets having a respective reflective intensity that varies in accordance with a position of the respective facet along the propagation path.

2. The light guide of claim 1, wherein the respective reflective intensity for each reflective facet of the series of reflective facets increases with a distance from the incoupling structure.

3. The light guide of claim 1, wherein the respective reflective intensity of the series of reflective facets is modulated via a respective surface area of the reflective facets.

4. The light guide of claim 3, wherein a first reflective facet of the series of reflective facets is further along the propagation path than a second reflective facet of the series of reflective facets, and wherein a surface area of the first reflective facet is greater than a surface area of the second reflective facet.

5. The light guide of claim 1, wherein the respective reflective intensity of the series of reflective facets is modulated via one or more optical coatings applied to the reflective facets, such that a first set of one or more optical coatings is applied to a first reflective facet of the series of reflective facets, and such that a second set of one or more optical coatings is applied to a second reflective facet of the series of reflective facets, the first set different than the second set.

6. The light guide of claim 1, wherein a first reflective facet of the series of reflective facets is further along the propagation path than a second reflective facet of the series of reflective facets, and wherein the reflective intensity of the first reflective facet is greater than the reflective intensity of the second reflective facet.

7. The light guide of claim 1, wherein each reflective facet of the series of reflective facets is substantially parallel with respect to other reflective facets of the series of reflective facets.

8. The light guide of claim 1, wherein a respective distance between the eyebox and each reflective facet of the series of reflective facets is substantially identical.

9. The light guide of claim 1, wherein a respective distance between the eyebox and each reflective facet of the series of reflective facets varies in accordance with the position of the respective facet along the propagation path.

10. (canceled)

11. A method comprising:
receiving display light into a light guide via an incoupling structure;
directing the display light through the light guide along a propagation path; and
outcoupling at least a portion of the display light toward an eyebox of the light guide via a reflective structure comprising a series of reflective facets, the reflective facets having a respective reflective intensity that varies in accordance with a distance between the incoupling structure and the respective facet.

12. The method of claim 11, wherein the respective reflective intensity for each reflective facet of the series of reflective facets increases with the distance between the incoupling structure and the respective facet.

13. The method of claim 11, further comprising modulating the respective reflective intensity of the series of reflective facets by configuring a respective surface area of the reflective facets.

14. The method of claim 13, wherein a first reflective facet of the series of reflective facets is further from the incoupling structure than a second reflective facet of the series of reflective facets, and wherein configuring the respective surface area of the reflective facets includes configuring the first reflective facet to have a greater surface area than a surface area of the second reflective facet.

15. The method of claim 11, further comprising applying a first set of one or more optical coatings to a first reflective facet of the series of reflective facets, and applying a second set of one or more optical coatings to a second reflective facet of the series of reflective facets, the first set being different than the second set.

16. The method of claim 11, wherein a first reflective facet of the series of reflective facets is further along the propagation path than a second reflective facet of the series of reflective facets, and wherein the reflective intensity of the first reflective facet is greater than the reflective intensity of the second reflective facet.

17. The method of claim 11, wherein each reflective facet of the series of reflective facets is substantially parallel with respect to other reflective facets of the series of reflective facets.

18. The method of claim 11, wherein a respective distance between the eyebox and each reflective facet of the series of reflective facets is substantially identical.

19. The method of claim 11, wherein a respective distance between the eyebox and each reflective facet of the series of reflective facets varies in accordance with the distance between the incoupling structure and the reflective facet.

20. (canceled)

21. An eyewear display device comprising:
a light guide, comprising:
an incoupling structure to receive display light and to direct the display light into the light guide along a propagation path; and
a reflective structure to outcouple at least a portion of the display light toward an eyebox of the light guide, the reflective structure comprising a series of reflective facets having a respective reflective intensity that varies in accordance with a position of the respective facet along the propagation path.

22. The eyewear display device of claim 21, wherein each reflective facet of the series of reflective facets is substantially parallel with respect to other reflective facets of the series of reflective facets.
